(19) United States
(12) Patent Application Publication
(10) Pub. No.: US 2025/0191836 A1
(43) Pub. Date: Jun. 12, 2025

(54) Electronic Component And Method For Holding Conducting Wire End

(71) Applicant: SUMIDA CORPORATION, Tokyo (JP)

(72) Inventors: Hitoshi MORIYA, Natori City (JP); Yasunori MORIMOTO, Natori City (JP); Ryota ISHII, Natori City (JP); Kenta CHIBA, Natori City (JP); Ryuta KOSAI, Natori City (JP)

(21) Appl. No.: 19/059,509

(22) Filed: Feb. 21, 2025

Related U.S. Application Data
(63) Continuation of application No. PCT/JP2022/035185, filed on Sep. 21, 2022.

(51) Int. Cl. H01F 27/29; H01F 41/10

(52) U.S. Cl. CPC H01F 27/292; H01F 41/10

(57) ABSTRACT

An electronic component includes: a conducting wire having conductivity; and a conductive member having a bent terminal that holds an end of the conducting wire. The bent terminal includes: a base portion that supports the conducting wire; a folding portion that is continuous from one end side of the base portion and that is bent and folded back; and a bending portion that is continuous from the folding portion and that is provided to a distal end side opposite to the base portion. The conducting wire is sandwiched between the base portion and the folding portion or the bending portion. The bending portion is bent toward a side closer to the base portion than a tangential direction of the folding portion, so that a gap between the bending portion and the base portion is smaller than a width of the conducting wire.

### CROSS REFERENCE TO RELATED APPLICATIONS

This application is a Continuation of International Patent Application No. PCT/JP2022/035185, filed on Sep. 21, 2022, which is expressly incorporated herein by reference in its entirety.

### BACKGROUND

### Technical Field

The present invention relates to an electronic component that includes a conducting wire and a bent terminal that holds an end of the conducting wire, and a method for holding the end of the conducting wire.

### Related Art

Japanese Patent Laid-Open No. 2019-91736 discloses a coil component that includes a conducting wire (referred to as a wire end in the same document), and a conductive member (referred to as a metal terminal in the same document) having a bent terminal (referred to as a folding piece in the same document) that holds an end of the conducting wire. The bent terminal includes a base portion, and a flat plate shaped folding portion (referred to as the folding piece in the same document) that is bent at a substantially right angle from the base portion. In a state in which the conducting wire is disposed on the base portion, the bent terminal is crimped so that the folding portion is bent toward the base portion, to hold the conducting wire.

A method for crimping and fixing a conducting wire disclosed in Japanese Patent Laid-Open No. 2019-91736 easily causes an outward movement (a movement in a direction away from a bending fulcrum of the folding portion) of the conducting wire when the flat plate shaped folding portion is bent to hold the conducting wire (at the time of crimping). Therefore, there is still a room for improvement in view of electrical and physical connections between the conducting wire and the conductive member.

The outward movement of the conducting wire occurs when the conducting wire is pressed by the folding portion bent to be deformed at the time of crimping.

The present invention has been made in view of the above problem, and has an object to provide an electronic component that can provide electrically and physically stable connections between a conducting wire and a conductive member, and a method for holding an end of the conducting wire.

### SUMMARY

An electronic component according to the present invention includes a conducting wire having conductivity, and a conductive member having a bent terminal that holds an end of the conducting wire. The bent terminal includes a base portion that supports the conducting wire, a folding portion that is continuous from one end side of the base portion and that is bent and folded back, and a bending portion that is continuous from the folding portion and that is provided to a distal end side which is an opposite side to the base portion. The conducting wire is sandwiched between the base portion and the folding portion or the bending portion. The bending portion is bent toward a side closer to the base portion than a tangential direction of the folding portion, so that a gap between the bending portion and the base portion is smaller than a width of the conducting wire.

A method for holding a conducting wire end according to the present invention includes preparing an electronic component that includes a conducting wire having conductivity, and a conductive member having a bent terminal that holds an end of the conducting wire, the bent terminal including a base portion that supports the conducting wire, a folding portion that is continuous from one end side of the base portion, that is bent and folded back, and a bending portion that is continuous from the folding portion and that is provided to a distal end side which is an opposite side to the base portion, and that is bent toward a side closer to the base portion than a tangential direction of the folding portion, disposing the conducting wire between the base portion and the folding portion or the bending portion by passing the conducting wire between the distal end and the base portion in the bent terminal, and crimping the bent terminal to crush the conducting wire between the folding portion or the bending portion and the base portion after the disposing. A gap between the bending portion and the base portion at the timing of the disposing is greater than a width of the conducting wire, and a gap between the bending portion and the base portion after the crimping is smaller than a width of the conducting wire.

### EFFECT OF THE INVENTION

According to the present invention, there is provided an electronic component and a method for holding an end of the conducting wire that can provide electrically and physically stable connections between a conducting wire and a conductive member.

### BRIEF DESCRIPTION OF THE DRAWINGS

FIG. 1 is a perspective view of a coil component.

FIG. 2 is a sectional view of a bent terminal shown in II of FIG. 1, the bent terminal being in a state after being crimped.

FIG. 3 is a sectional view of the bent terminal shown in II of FIG. 1, the bent terminal being in a state before being crimped.

FIG. 4 is a sectional view of a bent terminal shown in II of FIG. 1, and showing the bent terminal according to a first modified example.

FIG. 5 is a diagram showing a bent terminal according to a second modified example.

FIG. 6 is a diagram showing a bent terminal according to a third modified example.

### DETAILED DESCRIPTION

Hereinafter, embodiments of the present invention will be described with reference to the drawings.

The embodiments described below merely represent examples for facilitating understanding of the present invention, and are not intended to limit the present invention. That is, shapes, dimensions, arrangements, and the like of members described below may be modified or improved without departing from the spirit and scope of the present invention, and needless to say, the present invention includes equivalents thereof.

Furthermore, various constituent elements of the present invention do not necessarily have to be independent of each other. A plurality of constituent elements may be formed as a single constituent element. One constituent element may be formed by being divided into a plurality of constituent elements. A certain constituent element may be a part of another constituent element. A part of a certain constituent element may overlap with a part of another constituent element.

In all the drawings, similar constituent elements will be denoted by the same reference numerals, and redundant description will not be repeated. While descriptions may be given in the present specification by defining up-down directions, the up-down directions are merely set for the sake of convenience for explaining correspondence relationships among constituent elements and are not intended to limit directions during production or during use of products according to the present invention. In particular, in the present embodiment, a mounting direction refers to the up direction, a direction opposite to the up direction refers to the down direction, and the up-down direction is not necessarily matched with the up-down direction in the gravity direction.

### Outline of Coil Component

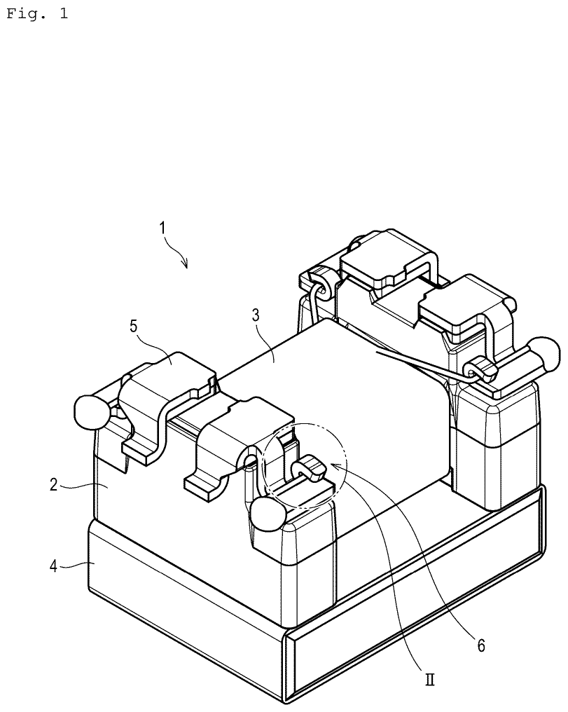

First, an outline of a coil component 1 will be described mainly with reference to FIGS. 1 to 3.

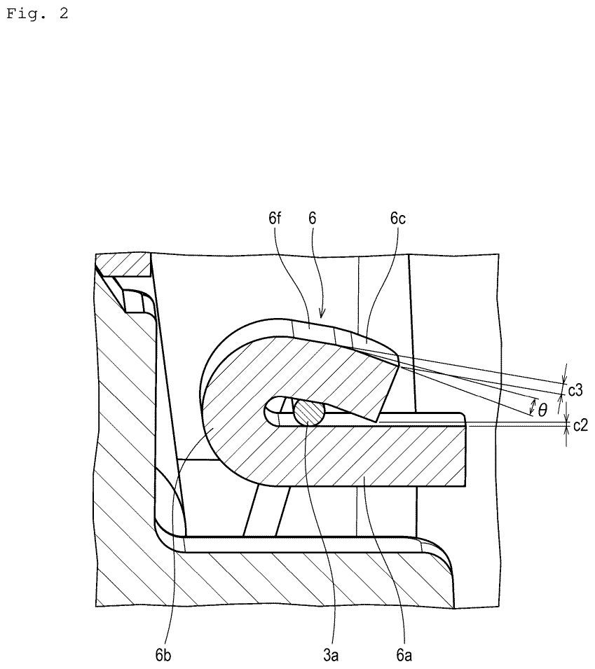

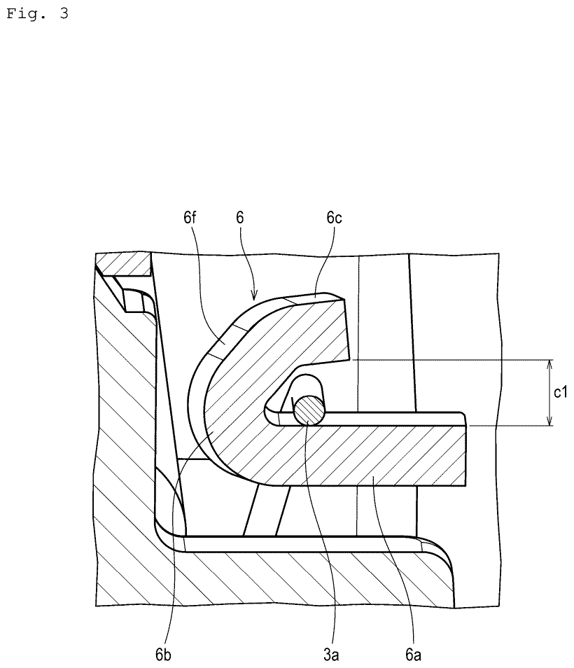

FIG. 1 is a perspective view of the coil component 1. FIG. 2 is a sectional view of a bent terminal 6 shown in II of FIG. 1, the bent terminal 6 being in a state after being crimped. FIG. 3 is a sectional view of the bent terminal 6 shown in II of FIG. 1, the bent terminal 6 being in a state before being crimped.

For generally showing a conductive member 5, FIG. 1 shows the coil component 1 in a state in which a mounting surface to be mounted on a substrate is positioned upward or in a state of facing a direction opposite from a general mounting direction on the substrate. Hereinafter, the up-down direction will be described with respect to the up-down direction in FIG. 1.

An electronic component (coil component 1) according to the present embodiment includes a conducting wire 3a having conductivity, and a conductive member 5 having a bent terminal 6 that holds an end of the conducting wire 3a.

The bent terminal 6 includes a base portion 6a that supports the conducting wire 3a, a folding portion 6b that is continuous from one end side of the base portion 6a and that is bent and folded back, and a bending portion 6c that is continuous from the folding portion 6b and that is provided to a distal end side which is an opposite side to the base portion 6a.

The conducting wire 3a is sandwiched between the base portion 6a and the folding portion 6b or the bending portion 6c.

The bending portion 6c is bent toward a side closer to the base portion 6a than a tangential direction of the folding portion 6b, so that a gap between the bending portion 6c and the base portion 6a is smaller than a width of the conducting wire 3a.

Here, a “boundary” between the folding portion 6b and the bending portion 6c refers to a portion where in the bent terminal 6, a curvature changes on a side closer to a distal end than a fold point of the folding portion 6b, and also refers to a distal end (a distal end of a straight line portion 6f, which will be described later, in the present embodiment) of the folding portion 6b in an outer surface (an upper surface) of the bent terminal 6 as viewed from a direction (a width direction of the bent terminal 6) perpendicular to a virtual plane (a planar surface including an up-down direction and a right-left direction in FIG. 2 in a plane) including extending directions of the folding portion 6b and the bending portion 6c.

The “tangential direction of the folding portion 6b” refers to a tangential direction in the distal end of the folding portion 6b (the boundary between the distal end of the folding portion 6b and the bending portion 6c), and in the present embodiment, refers to an extending direction of the straight line portion 6f, which will be described later.

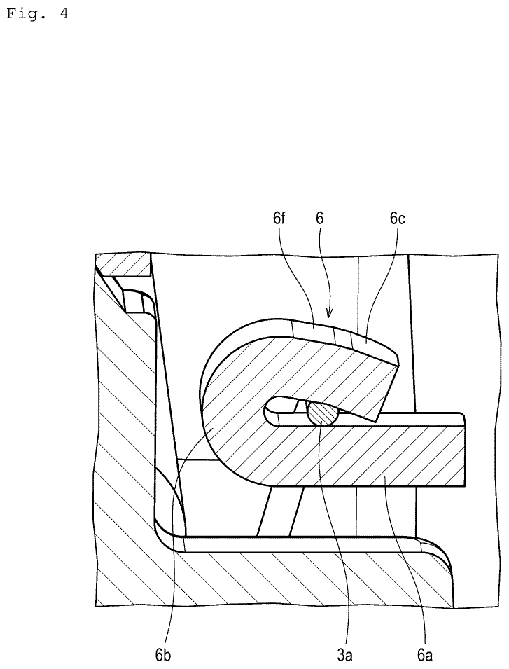

For example, unlike FIG. 4, in a configuration that the folding portion 6b is bent at a predetermined curvature beyond the fold point without including the straight line portion 6f, a portion beyond a portion that is bent at a relatively high curvature to approach the base portion 6a side compared with the portion that is bent at this predetermined curvature refers to the bending portion 6c.

In this specification, in the bent terminal 6, the bending portion 6c does not refer to only a portion where an inclination changes from that of the folding portion 6b, and refers to a portion extending to the distal end from the portion where the inclination changes from that of the folding portion 6b.

That is, if a linearly extending portion is present on a side closer to the distal end than the portion where an inclination changes from that of the folding portion 6b, the bending portion 6c includes the linearly extending portion. This content applies to bending portions 16c and 26c, which will be described later.

Regarding the above-described “base portion 6a that supports the conducting wire 3a”, the base portion 6a is not limited to one that always supports the conducting wire 3a.

That is, the base portion 6a may be provided at a position limiting the movement of the conducting wire 3a to be away from the conducting wire 3a so that the base portion 6a can contact and support the conducting wire 3a after the crimping is performed.

The above-described phrase “a gap between the bending portion 6c and the base portion 6a is smaller than a width of the conducting wire 3a.” includes the meaning that there is no “gap between the bending portion 6c and the base portion 6a”. That is, it includes the meaning that the bending portion 6c is configured to contact the base portion 6a. In this embodiment, the tip of the bending portion 6c is separated from the base portion 6a (in particular, the top surface of the base portion 6a). In other words, there is a gap with a separation distance c2 shown in FIG. 2 between the tip of the bending portion 6c and the top surface of the base portion 6a. The gap between the bending portion 6c and the base portion 6a in this embodiment gradually becomes smaller towards the tip of the bending portion 6c. The gap between the bending portion 6c and the base portion 6a allows the bending portion 6c (or the straight line portion 6f, as described below) to be displaced like a spring. As a result, the bending portion 6c (or the straight line portion 6f) can firmly and stably hold the conducting wire 3a between it and the base portion 6a.

The above-described “width” means a wire diameter in the case of a round wire, or a thickness in the case of a rectangular wire (a length of a short side in a cross section of the rectangular wire).

For example, in the case where the bending portion 6c is not formed in the bent terminal 6, or in the case where a portion beyond the folding portion 6b extends linearly, the portion beyond the folding portion 6b in the bent terminal 6 contacts the conducting wire 3a at one point as viewed from side when the bent terminal 6 is crimped. The point contact portion is shifted depending on the crimping amount to make it easy for a push load from the bent terminal 6 to the conducting wire 3a to be always applied to the outside, which may cause the conducting wire 3a to be shifted to the outside and come off from the bent terminal 6.

According to the above-described configuration, the bending portion 6c that is bent toward a side closer to the base portion 6a than a tangential direction of the folding portion 6b is provided, so that the bending portion 6c serves as a stopper limiting the movement of the conducting wire 3a.

In other words, even when the conducting wire 3a is pushed out toward the folding portion 6b or the bending portion 6c in the bent terminal 6 when the bent terminal 6 is bent (crimped), the bending portion 6c can help to prevent the conducting wire 3a from coming off from between the base portion 6a and the folding portion 6b or the bending portion 6c.

As an electronic component according to the present invention, an example of the coil component 1 as a common mode choke coil is described in the present embodiment, but the present invention is not limited to such a configuration. For example, the present invention is adaptable to not only the coil component 1, but also a general electronic component having a bent terminal that holds a conducting wire.

A method for holding a conducting wire end according to the present embodiment includes preparing the above-described electronic component (coil component 1), disposing the conducting wire 3a between the base portion 6a and the folding portion 6b or the bending portion 6c by passing the conducting wire 3a between a distal end and the base portion 6a in the bent terminal 6, and crimping the bent terminal 6 to crush the conducting wire 3a between the folding portion 6b or the bending portion 6c and the base portion 6a after the disposing.

A gap between the bending portion 6c and the base portion 6a at the timing of the disposing (separation distance c1 shown in FIG. 3) is greater than a width of the conducting wire 3a, and a gap between the bending portion 6c and the base portion 6a after the crimping (separation distance c2 shown in FIG. 2) is smaller than a width of the conducting wire 3a. Here, the width of conducting wire 3a is a dimension of conducting wire 3a in the up-down direction (the direction of separation between the tip of the bending portion 6c and the base portion 6a).

According to the above-described configuration, since the gap between the bending portion 6c and the base portion 6a at the timing of the disposing is greater than the width of the conducting wire 3a, the conducting wire 3a can be smoothly disposed in the disposing. Furthermore, since the gap between the bending portion 6c and the base portion 6a after the crimping is smaller than the width of the conducting wire 3a, the conducting wire 3a can be prevented from coming off from between the base portion 6a and the folding portion 6b or the bending portion 6c after the crimping.

That is, since the bending portion 6c is formed in the bent terminal 6 (a portion bent toward the base portion 6a side is provided before the crimping), the bending portion 6c can serve as a stopper limiting the movement of the conducting wire 3a.

The folding portion 6b includes the straight line portion 6f linearly extending beyond a portion folded upward from the base portion 6a side. The straight line portion 6f is located at the distal end side of the folding portion 6b and at the proximal end side of the bending portion 6c.

The straight line portion 6f in the folding portion 6b linearly extends obliquely downward, in other words, while being inclined downward to approach the base portion 6a in a direction from the proximal end side to the distal end side. In other words, a dimension of the bending space of the folding portion 6b in the up-down direction gradually decrease from the folding point of the folding portion 6b towards the tip of the bending terminal 6 (the tip of the bending portion 6c). The bending space is an inner space between the folding portion 6b, the straight line portion 6f, the bending portion 6c and the base portion 6a (in particular, the space between the straight line portion 6f and the base portion 6a). The dimension in up-down direction of the space on the side of the folding point next to the conducting wire 3a in the bending space is larger than the width of the conducting wire 3a.

An inclination angle of the straight line portion 6f is preferably equal to or more than 2 degrees and equal to or less than 30 degrees, and more preferably equal to or more than 5 degrees and equal to or less than 25 degrees with respect to the upper surface (a horizontal surface and a surface in contact with the conducting wire 3a) of the base portion 6a.

A length of the straight line portion 6f is preferably equal to or more than 1 time and equal to or less than 5 times, and more preferably equal to or more than 1.5 times and equal to or less than 3 times with respect to a width (a length in the width direction in the case of a rectangular wire (in the long side direction in a cross section of the rectangular wire)) of the conducting wire 3a.

According to the above-described configuration, the straight line portion of having a downward inclined wall surface and/or the bending portion 6c can always elastically bias the conducting wire 3a toward the rear side (the fold point side of the folding portion 6b, or left side in FIG. 2) where the folding portion 6b makes a U turn by crimping from the straight line portion 6f. In other words, the direction of the stress applied to the conducting wire 3a by the straight line portion 6f and/or the bending portion 6c is towards the lower left in FIG. 2. The direction of the stress has a component in the direction towards the folding point (towards the left in FIG. 2) and a component in the direction towards the base portion 6a (downwards in FIG. 2). The conducting wire 3a contacts the wall surface, so that the conducting wire 3a does not play in a bending space of the folding portion 6b. Specifically, the conducting wire 3a applies stress to the straight line portion 6f and/or the bending portion 6c in the direction of the top right in FIG. 2, in an attempt to restore it elastically to its original state. In other words, the conducting wire 3a is in pressure contact with the straight line portion 6f and/or the bending portion 6c like a spring. This allows the conducting wire 3a to be fixed sufficiently between the straight line portion 6f and/or the bending portion 6c and the base portion 6a. Therefore, the holding position of the conducting wire 3a for each product individual is stable without variations, making it easy for a worker or a working device to cut the conducting wire 3a to conform to the end of the conductive member 5 and to define a position of the conducting wire 3a to be irradiated with laser.

In particular, a portion that holds the conducting wire 3a is a straight line portion in the straight line portion 6f or the bending portion 6c, making it easy to apply a load in a holding direction to the conducting wire 3a between the base portion 6a and the straight line portion in the straight line portion 6f or the bending portion 6c and making it possible to increase a holding force applied to the conducting wire 3a to stabilize the position of the conducting wire 3a when being irradiated with laser, which will be described later.

In this embodiment, the conducting wire 3a is sandwiched between the base portion 6a and the straight line portion 6f. In other words, the conducting wire 3a is sandwiched between the top surface (the inner surface facing the bending space) of the base portion 6a and the bottom surface (the inner surface facing the bending space) of the straight line portion 6f, which slopes down towards the tip side with respect to the top surface of the base portion 6a.

### Overall Configuration

The coil component 1 according to the present embodiment includes a drum core 2, a coil 3 formed of the conducting wire 3a wound at a center of the drum core 2, an I core 4 connected to both ends of the drum core 2 to form a magnetic circuit together with the drum core 2, and the conductive member 5 to which an end of the conducting wire 3a is connected.

The four conductive members 5 are provided at respective four corners on the upper surface of the coil component 1, and each has the bent terminal 6 that holds the end of the conducting wire 3a of the coil 3 on an outer side in the width direction perpendicular to the axial direction of the coil 3. The conductive member 5 includes a mounting plane to be mounted on a printed circuit board on an uppermost surface, a bridged portion extending outward in the width direction and downward from the mounting plane, and the bent terminal 6 connected to the bridged portion.

### Terminal

The bent terminal 6 will be described mainly with reference to FIGS. 2 and 3.

The bent terminal 6 includes the base portion 6a extending horizontally from a lower end of the bridged portion on which the conducting wire 3a is mounted, the folding portion 6b that is folded back from the inside to the outside in the width direction (in the horizontal surface, a direction perpendicular to an axial direction of the coil 3) of the coil component 1 in the base portion 6a, and the bending portion 6c provided on a side closer to the distal end than the folding portion 6b.

At each of the four corners of the upper surface of the coil component 1 in FIG. 1, a farthest end of the conducting wire 3a and the ends on both outer sides in the axial direction of the conductive member 5 are welded, whereby a welding bead is formed as shown in FIG. 1. At each of the ends on both outer sides in the axial direction of the conductive member 5, the bent terminal 6 is formed before welding, but is melted by welding, whereby the above-described welding bead is formed.

However, the present invention is not limited to such a configuration, and is not limited to a configuration in which the two bent terminals 6 are formed in each of the four corners of the upper surface of the coil component 1 in FIG. 1, and only one bent terminal 6 may be formed in each of the four corners. Furthermore, for example, only two bent terminals 6 may be formed in the coil component 1.

A bending angle θ of the bending portion 6c as shown in FIG. 2 is preferably equal to or more than 25 degrees and equal to or less than 45 degrees with respect to a tangential direction of the folding portion 6b (a portion in the folding portion 6b adjacent to the bending portion 6c).

In the present embodiment, the folding portion 6b has the straight line portion 6f, the bending portion 6c also has the straight line portion, and the bending angle θ refers to an angle of the straight line portion in the bending portion 6c with respect to an extending direction (the same as the tangential direction of the portion adjacent to the bending portion 6c) of the straight line portion 6f of the folding portion 6b.

According to the above-described configuration, the bending portion 6c (a first bending portion 16d, which will be described later) is in this angle range, thereby making it possible to suppress hindrance of the crimping operation by reducing a reaction force generated, if any, when the distal end of the bent terminal 6 contacts the base portion 6a while limiting the operation range of the conducting wire 3a.

Specifically, the “tangential direction of the folding portion 6b” refers to a tangential direction of the outer surface (an upper surface which is a surface on a side pressed by punch of a crimping tool (not shown in the drawings)) of the folding portion 6b as viewed from a direction perpendicular to the virtual plane including the extending directions of the folding portion 6b and the bending portion 6c.

However, the present invention is not limited to such a configuration, and the bending angle of the bending portion 6c may be perpendicular to the tangential direction of the folding portion 6b with the object to restrict the position of the conducting wire 3a.

In this embodiment, the bending amount c3 shown in FIG. 2 of the bending portion 6c is smaller than the line width of the conducting wire 3a. The bending amount c3 is the shortest distance to the tip of the bending portion 6c in a direction perpendicular to the outer surface (top surface) of the straight line portion 6f. Since the folding amount c3 is smaller than the width of the conducting wire 3a, when the folding portion 6b is folded back, the bending portion 6c is unlikely to prevent the folding portion 6b from being sufficiently folded back by coming into contact with the base portion 6a. Furthermore, as a result of the folding portion 6b being sufficiently folded back, the tip of the bending portion 6c may come into contact with the base portion 6a, or it may be separated from the base portion 6a.

Alternatively, the bending amount c3 of the bending portion 6c may be the same as or larger than the width of the conducting wire 3a.

A length of the bending portion 6c is preferably equal to or more than 0.5 times and equal to or less than 2 times, preferably equal to or more than 1 time, and more preferably equal to or less than 1.5 times with respect to a thickness of the bending portion 6c.

Here, the “length of bending portion 6c” refers to a length of a center portion in the thickness direction of the bending portion 6c.

For example, the thickness (thickness of the bent terminal 6) of the bending portion 6c according to the present embodiment is 0.1 mm, and the length of the bending portion 6c is 0.15 mm.

According to the above-described configuration, the length of the bending portion 6c is equal to or more than 0.5 times with respect to the thickness of the bending portion 6c, thereby making it easy to limit the movement of the conducting wire 3a. The length of the bending portion 6c is equal to or less than 2 times with respect to the thickness of the bending portion 6c, thereby making it possible to suppress the projection of the conducting wire 3a.

If the bending angle of the bending portion 6c with respect to the tangential line of the folding portion 6b is increased, the bending portion 6c may have a length shorter than the above-described length.

A thickness of the folding portion 6b is preferably equal to or more than 1.5 times and equal to or less than 3 times with respect to a diameter of the conducting wire 3a.

For example, the diameter of the conducting wire 3a is preferably 0.02 mm to 0.06 mm. The conducting wire 3a according to the present embodiment is a round wire, but is not limited to the round wire and may be a rectangular wire. In the case of the rectangular wire, the diameter of the conducting wire 3a is alternatively referred to as the thickness (the length in the up-down direction) of the conducting wire 3a.

According to the above-described configuration, the thickness of the folding portion 6b is equal to or more than 1.5 times with respect to the diameter of the conducting wire 3a, thereby making it possible to preferably hold the conducting wire 3a. The thickness of the folding portion 6b is equal to or less than 3 times with respect to the diameter of the conducting wire 3a, making it easy to bend the bending portion 6c formed integrally with the folding portion 6b at the time of the crimping.

### Manufacturing Method

Next, a method of manufacturing the bent terminal 6 that holds the conducting wire 3a will be described.

A plurality of conductive members 5 are formed into hoop materials (not shown in the drawings). The plurality of conductive members 5 each are provided with the bent terminal 6 in which the bending portion 6c in a state shown in FIG. 3 is formed by press working of punching in a stage of base stock.

Specifically, the above-described press working is performed by pressing the punch of the crimping tool against the bending portion 6c from above in a state in which the jig is disposed on the lower side of the folding portion 6b and above the base portion 6a to bend the bending portion 6c by the crimping tool (not shown in the drawings).

This conductive member 5 is bonded to the drum core 2 (ferrite) and a wire is wound around the drum core 2 to form the coil 3 (two coils 3 in the present embodiment). The conducting wire 3a (four conducting wires 3a in the present embodiment) which is a terminal of the coil 3 is disposed between the base portion 6a and the bending portion 6c in the bent terminal 6.

The conducting wire 3a drawn out from the coil 3 is temporarily fixed to the jig (not shown in the drawings) located on an outer side than the conductive member 5. In a state in which the conducting wire 3a is fixed by the jig (not shown in the drawings), the folding portion 6b and the folding portion 6c in the bent terminal 6 are crimped by press working. By this crimping, the conducting wire 3a is held between the bending portion 6b and/or the bending portion 6c and the base portion 6a. That is, by the crimping work, the folding portion 6b or the bending portion 6c is bent and deformed to the position where the conducting wire 3a is crushed under pressure from the folding portion 6b or the bending portion 6c. This makes it possible to stably maintain the electrical connection between the conducting wire 3a and the conductive member 5.

In a state in which the conducting wire 3a is held by this holding, the fixation by the jig (not shown in the drawings) is released, the excess length of the conducting wire 3a is cut, and then the end of the conductive member 5 and the distal end of the conducting wire 3a are irradiated with laser to be melted and integrated, whereby the welding bead is formed.

In a state before the bent terminal 6 is crimped as shown in FIG. 3, a gap between the lower end of the bending portion 6c and the upper surface of the base portion 6a is greater than a diameter of the conducting wire 3a.

In the axial direction of the bent terminal 6, the rate of change in bend of the folding portion 6b in the bent terminal 6 is greater than the rate of change in bend of the bending portion 6c before and after the crimping. Then, the rate of change in bend of the folding portion 6b after the crimping is greater than the rate of change in bend of the folding portion 6b before the crimping.

### First Modified Example

Next, a first modified example will be described with reference to FIG. 4. FIG. 4 is a sectional view of the bent terminal 6 shown in II of FIG. 1, and showing the bent terminal 6 according to the first modified example.

As shown in FIG. 4, in the bent terminal 6 according to the first modified example, the conducting wire 3a is held at three places of the base portion 6a, the folding portion 6b, and the bending portion 6c. The conducting wire 3a is held by the base portion 6a, the folding portion 6b and the bending portion 6c.

According to the above-described configuration, the conducting wire 3a can be brought into a state of having no play, whereby the conducting wire 3a can be firmly held by the base portion 6a, the folding portion 6b, and the bending portion 6c.

That is, holding the conducting wire 3a at three places makes it possible to limit the horizontal movement of the conducting wire 3a by the folding portion 6b and the bending portion 6c while limiting the vertical movement of the conducting wire 3a by the base portion 6a, the folding portion 6b, and the bending portion 6c.

### Second Modified Example

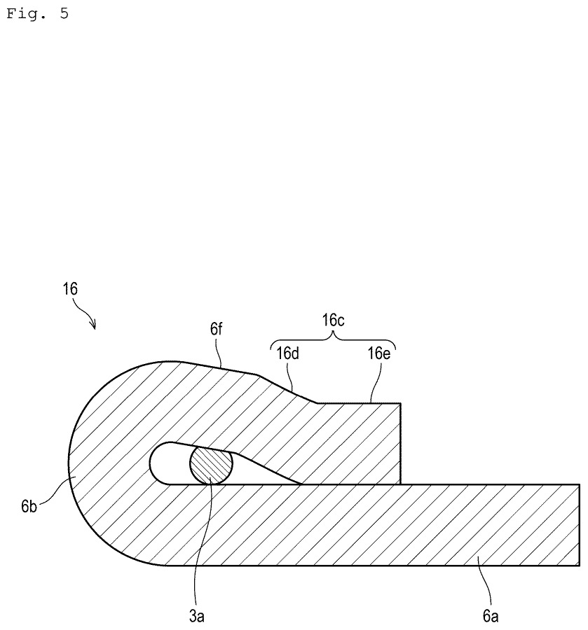

Next, a bending portion 16c according to a second modified example will be described mainly with reference to FIG. 5. FIG. 5 is a diagram showing a bent terminal 16 according to the second modified example.

The bending portion 16c in the bent terminal 16 includes, in addition to a first bending portion 16d that is bent toward a side approaching the base portion 6a, a second bending portion 16e that is located on a side closer to a distal end than the first bending portion 16d and is bent toward a side opposite to a bending direction of the first bending portion 16d.

Then, in the bending portion 16c, the second bending portion 16e is formed along the base portion 6a.

In this embodiment, the second bending portion 16e is along the base portion 6a and is in contact with or pressed against the base portion 6a. More specifically, the lower surface of the second bending portion 16e is in face contact with the upper surface of the base portion 6a. In other words, the area of the bending portion 16c from the boundary portion between the first bending portion 16d and the second bending portion 16e to the tip of the bent terminal 6 is in face contact with the base portion 6a.

In addition, in this embodiment, the bending space is closed at the tip of the bent terminal 6 by the configuration in which part of the bending portion 16c is in contact with part of the base portion 6a.

In the bent terminal 16, the first bending portion 16d does not refer to only a portion where an inclination changes from that of the folding portion 6b, and refers to a portion extending to the second bending portion 16e from the portion where the inclination changes from that of the folding portion 6b. This content applies to a first bending portion 26d, which will be described later.

The second bending portion 16e does not refer to only a portion where an inclination changes from that of the first bending portion 16d, and refers to a portion extending to the distal end from the portion where the inclination changes from that of the first bending portion 16d. This content applies to a second bending portion 26e, which will be described later.

The distal end (the second bending portion 16e) of the bending portion 16c according to the present example is pressed against the base portion 6a by the punch of the crimping tool (not shown in the drawings), and is bent in a direction along the base portion 6a.

Specifically, the above-described “second bending portion 16e that is bent toward a side opposite to a bending direction of the first bending portion 16d” means that the second bending portion 16e is bent toward a side (upper side with respect to the tangential direction of the first bending portion 16d and the horizontal direction in FIG. 5) opposite to the bending direction (or a downward direction in FIG. 5 which is a direction approaching the base portion 6a) of the first bending portion 16d with respect to the tangential direction of the folding portion 6b.

According to the above-described configuration, the second bending portion 16e is along the base portion 6a, whereby the state in which the conducting wire 3a is held by the bending portion 16c can be further stabilized and the conducting wire 3a can be prevented from coming off from a gap between the bending portion 16c and the base portion 6a.

Such a bending portion 16c is formed by pressing the punch (not shown in the drawings) used for the crimping against the second bending portion 16e until the second bending portion 16e presses the base portion 6a.

The bending portion 16c is preferably brought into abutment with the base portion 6a to be in press-contact with the base portion 6a. The term “abutment” is not limited to point contact and line contact, and as shown in FIG. 5, plane contact corresponds to the abutment.

According to the above-described configuration, it becomes difficult for the conducting wire 3a to come out from a gap between the bending portion 16c and the base portion 6a.

In the present example, the length of the first bending portion 16d is substantially the same as the length of the second bending portion 16e, but the length of the first bending portion 16d is different from the length of the second bending portion 16e.

In this embodiment, the bent terminal 6 has the straight line portion 6f described above. More specifically, the straight line portion 6f and the first bending portion 16d are inclined so as to approach the base portion 6a towards the tip of the bent terminal 6. In addition, the angle of inclination of the straight line portion 6f relative to the top surface of the base portion 6a (the angle formed by the top surface of the base portion 6a and the outer surface of the straight line 6f) is smaller than the angle of inclination of the first bending portion 16d relative to the top surface of the base portion 6a (the angle formed by the top surface of the base portion 6a and the outer surface of the first bending portion 16d).

Also, as mentioned above, in this embodiment, the second bending portion 16e is along with the base portion 6a. In other words, the inclination angle of the straight line portion 6f with respect to the top surface of the base portion 6a is greater than the inclination angle of the second bending portion 16e with respect to the top surface of the base portion 6a (the angle formed by the top surface of the base portion 6a and the outer surface of the second bending portion 16e).

### Third Modified Example

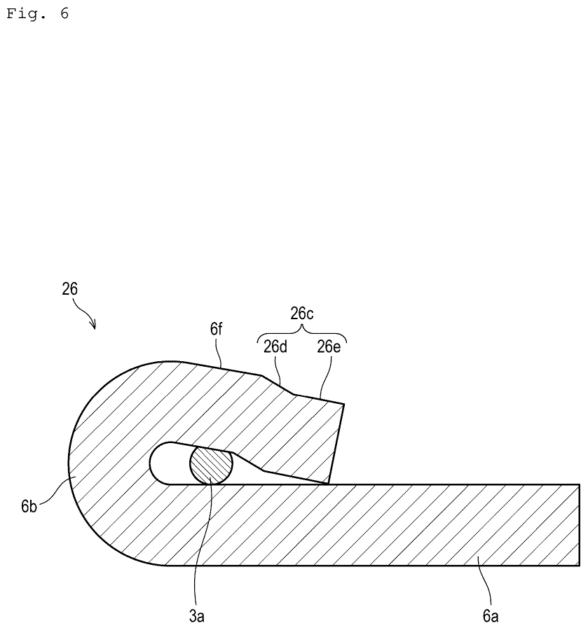

Next, a bent terminal 26 according to a third modified example will be described with reference to FIG. 6. FIG. 6 is a diagram showing the bent terminal 26 according to the third modified example.

The bent terminal 26 according to the present example includes, in addition to a first bending portion 26d that is bent toward a side approaching the base portion 6a, a second bending portion 26e that is located on a side closer to a distal end than the first bending portion 26d and is bent toward a side opposite to a bending direction of the first bending portion 26d. Then, a lower end of the distal end of the second bending portion 26e is brought into abutment (line contact) with the base portion 6a to be in press-contact with the base portion 6a.

Specifically, the above-described “second bending portion 26e that is bent toward a side opposite to a bending direction of the first bending portion 26d” means that the second bending portion 26e is bent in a bending direction which is a side (upper side with respect to the tangential direction of the first bending portion 26d and in FIG. 6, the oblique downward direction which is inclined at a shallower angle with respect to the base portion 6a than the first bending portion 26d) opposite to the bending direction (or a downward direction in FIG. 6 which is a direction approaching the base portion 6a) of the first bending portion 26d with respect to the tangential direction of the folding portion 6b.

The second bending portion 26e according to the present embodiment is preferably formed to be longer than the first bending portion 26d. Specifically, the second bending portion 26e may be formed to be 1.5 times longer than the first bending portion 26d.

Also in the above-described configuration, the lower end of the distal end of the second bending portion 26e is in press-contact with the base portion 6a, thereby making it difficult for the conducting wire 3a to come out from a gap between the bending portion 26c and the base portion 6a.

The above-described embodiment and modified examples include the following technical ideas.

(1)

An electronic component comprising:

a conducting wire having conductivity; and

a conductive member having a bent terminal that holds an end of the conducting wire

wherein the bent terminal includes:

a base portion that supports the conducting wire;

a folding portion that is continuous from one end side of the base portion and that is bent and folded back; and

a bending portion that is continuous from the folding portion and that is provided to a distal end side which is an opposite side to the base portion, and

wherein the conducting wire is sandwiched between the base portion and the folding portion or the bending portion, and

wherein the bending portion is bent toward a side closer to the base portion than a tangential direction of the folding portion, so that a gap between the bending portion and the base portion is smaller than a width of the conducting wire.

(2)

The electronic component according to (1), wherein the conducting wire is held by the base portion, the folding portion, and the bending portion.

(3)

The electronic component according to (1) or (2), wherein

the bending portion includes, in addition to a first bending portion that is bent toward a side approaching the base portion, a second bending portion that is located on a side closer to a distal end than the first bending portion and is bent toward a side opposite to a bending direction of the first bending portion, and

wherein in the bending portion, the second bending portion is formed along the base portion.

(4)

The electronic component according to any one of (1) to (3), wherein

the bending portion is brought into abutment with the base portion to be in press-contact with the base portion.

(5)

The electronic component according to any one of (1) to (4), wherein

the folding portion includes a straight line portion extending toward a side approaching the base portion in a direction from a proximal end side to a distal end side, in a portion beyond a portion folded from the base portion.

(6)

The electronic component according to (5), wherein

the straight line portion and/or the bending portion elastically bias the conducting wire toward a fold point side of the folding portion.

(7)

The electronic component according to (5) or (6), wherein

an inclination angle of the straight line portion is equal to or more than 2 degrees and equal to or less than 30 degrees with respect to a surface in contact with the conducting wire in the base portion.

(8)

The electronic component according to any one of (5) to (7), wherein

a length of the straight line portion is equal to or more than 1 time and equal to or less than 5 times with respect to a width of the conducting wire.

(9)

The electronic component according to any one of (1) to (8), wherein

a bending angle of the bending portion is equal to or more than 25 degrees and equal to or less than 45 degrees with respect to a tangential direction of the folding portion.

(10)

The electronic component according to any one of (1) to (9), wherein

a length of the bending portion is equal to or more than 0.5 times and equal to or less than 2 times with respect to a thickness of the bending portion.

(11)

The electronic component according to any one of (1) to (10), wherein

a thickness of the folding portion is equal to or more than 1.5 times and equal to or less than 3 times with respect to a diameter of the conducting wire.

(12)

A method for holding a conducting wire end, the method comprising:

preparing an electronic component that includes a conducting wire having conductivity, and a conductive member having a bent terminal that holds an end of the conducting wire,

the bent terminal including:
a base portion that supports the conducting wire;
a folding portion that is continuous from one end side of the base portion, that is bent and folded back; and
a bending portion that is continuous from the folding portion and that is provided to a distal end side which is an opposite side to the base portion, and that is bent toward a side closer to the base portion than a tangential direction of the folding portion,

disposing the conducting wire between the base portion and the folding portion or the bending portion by passing the conducting wire between the distal end and the base portion in the bent terminal; and

crimping the bent terminal to crush the conducting wire between the folding portion or the bending portion and the base portion after the disposing,

wherein a gap between the bending portion and the base portion at the time of the disposing is greater than a width of the conducting wire, and

wherein a gap between the bending portion and the base portion after the crimping is smaller than a width of the conducting wire.

1. An electronic component comprising:
a conducting wire having conductivity; and
a conductive member having a bent terminal that holds an end of the conducting wire
wherein the bent terminal includes:
a base portion that supports the conducting wire;
a folding portion that is continuous from one end side of the base portion and that is bent and folded back; and
a bending portion that is continuous from the folding portion and that is provided to a distal end side which is an opposite side to the base portion, and
wherein the conducting wire is sandwiched between the base portion and the folding portion or the bending portion, and
wherein the bending portion is bent toward a side closer to the base portion than a tangential direction of the folding portion, so that a gap between the bending portion and the base portion is smaller than a width of the conducting wire.

2. The electronic component according to claim 1, wherein the conducting wire is held by the base portion, the folding portion, and the bending portion.

3. The electronic component according to claim 1, wherein the bending portion includes, in addition to a first bending portion that is bent toward a side approaching the base portion, a second bending portion that is located on a side closer to a distal end than the first bending portion and is bent toward a side opposite to a bending direction of the first bending portion, and
wherein in the bending portion, the second bending portion is formed along the base portion.

4. The electronic component according to claim 1, wherein
the bending portion is brought into abutment with the base portion to be in press-contact with the base portion.

5. The electronic component according to claim 1, wherein
the folding portion includes a straight line portion extending toward a side approaching the base portion in a direction from a proximal end side to a distal end side, in a portion beyond a portion folded from the base portion.

6. The electronic component according to claim 1, wherein
a bending angle of the bending portion is equal to or more than 25 degrees and equal to or less than 45 degrees with respect to a tangential direction of the folding portion.

7. The electronic component according to claim 1, wherein
a length of the bending portion is equal to or more than 0.5 times and equal to or less than 2 times with respect to a thickness of the bending portion.

8. The electronic component according to claim 1, wherein
a thickness of the folding portion is equal to or more than 1.5 times and equal to or less than 3 times with respect to a diameter of the conducting wire.

9. A method for holding a conducting wire end, the method comprising:
preparing an electronic component that includes a conducting wire having conductivity, and a conductive member having a bent terminal that holds an end of the conducting wire,
the bent terminal including:
a base portion that supports the conducting wire;
a folding portion that is continuous from one end side of the base portion, that is bent and folded back; and
a bending portion that is continuous from the folding portion and that is provided to a distal end side which is an opposite side to the base portion, and that is bent toward a side closer to the base portion than a tangential direction of the folding portion,
disposing the conducting wire between the base portion and the folding portion or the bending portion by passing the conducting wire between the distal end and the base portion in the bent terminal; and
crimping the bent terminal to crush the conducting wire between the folding portion or the bending portion and the base portion after the disposing,
wherein a gap between the bending portion and the base portion at the time of the disposing is greater than a width of the conducting wire, and
wherein a gap between the bending portion and the base portion after the crimping is smaller than a width of the conducting wire.
